(19) United States
(12) Patent Application Publication
(10) Pub. No.: US 2020/0132887 A1
(43) Pub. Date: Apr. 30, 2020

(54) OPTICAL ELEMENT AND WEARABLE DISPLAY DEVICE

(71) Applicant: FUJIFILM Corporation, Tokyo (JP)

(72) Inventors: Akira YAMAMOTO, Minami-ashigara-shi (JP); Hiroshi SATO, Minami-ashigara-shi (JP); Yukito SAITOH, Minami-ashigara-shi (JP)

(73) Assignee: FUJIFILM Corporation, Tokyo (JP)

(21) Appl. No.: 16/728,855

(22) Filed: Dec. 27, 2019

Related U.S. Application Data
(63) Continuation of application No. PCT/JP2018/024925, filed on Jun. 29, 2018.

(30) Foreign Application Priority Data
Jun. 30, 2017 (JP) 2017-129187

(51) Int. Cl. G02B 3/00; G02B 3/12

(52) U.S. Cl. CPC G02B 3/0006; G02B 3/12

(57) ABSTRACT

Provided are an optical element and a wearable display device, the optical element being suitably applicable to a wearable display device in which a pixel grid of a display panel is inconspicuous to a user and the generation of moire is suppressed. The optical element includes: a support; and a plurality of dots that are arranged on the support and exhibit optical anisotropy, the dots are formed of a composition including a liquid crystal compound, and the optical element includes the dots having a slow axis in a direction different from a direction in which the plurality of dots are arranged.

### CROSS-REFERENCE TO RELATED APPLICATIONS

This application is a Continuation of PCT International Application No. PCT/JP2018/024925 filed on Jun. 29, 2018, which claims priority under 35 U.S.C. § 119(a) to Japanese Patent Application No. 2017-129187 filed on Jun. 30, 2017. The above application is hereby expressly incorporated by reference, in its entirety, into the present application.

### BACKGROUND OF THE INVENTION

### 1. Field of the Invention

The present invention relates to an optical element and a wearable display device.

### 2. Description of the Related Art

Recently, a wearable display device such as a head-mounted display has been widely used. This wearable display device is a device that displays an image in the very vicinity of the eyes of a user using an extended optical system employing a virtual image. In addition, in the wearable display device, in order to display an image at a wide viewing angle in front of the eyes of the user, an eyepiece for enlarging an image displayed on a display panel is used.

In the wearable display device, in a case where the image displayed on the display panel is enlarged using the eyepiece, a pixel grid included in the display panel is also enlarged together with the image, and the pixel grid of the display panel is visually recognized by the user. As a result, the quality of the image may deteriorate. In JP2016-139112A, a microlens array sheet is disposed between a display panel and an eyepiece to diffuse light from the display panel such that a pixel grid is prevented from being visually recognized by the user.

### SUMMARY OF THE INVENTION

JP2016-139112A discloses various countermeasures in order to prevent moire generated by interference between a two-dimensional spatial frequency of a pixel arrangement of a display panel and a two-dimensional spatial frequency of an arrangement pattern of microlenses in a microlens array sheet.

For example, a method of offsetting two-dimensional coordinates of a microlens center in the microlens array sheet from a pixel grid in the display panel is disclosed. However, it is difficult to prepare the microlens array sheet itself with this method, and this method is not industrially preferable.

It cannot be said that the countermeasures other than the above-described method are sufficient, and further improvement is required.

The present invention has been made in consideration of the above-described circumstances, and an object thereof is to provide an optical element that is suitably applicable to a wearable display device in which a pixel grid of a display panel is inconspicuous to a user and the generation of moire is suppressed.

In addition, another object of the present invention is to provide a wearable display device including the above-described optical element.

As a result of a thorough investigation on the above-described objects, the present inventors found that the desired effects can be obtained by using a predetermined optical element.

That is, it was found that the objects can be achieved by the following configurations.

(1) An optical element comprising:

a support; and

a plurality of dots that are arranged on the support and exhibit optical anisotropy,

in which the dots are formed of a composition including a liquid crystal compound, and

the optical element comprises the dots having a slow axis in a direction different from a direction in which the plurality of dots are arranged.

(2) The optical element according to claim 1, comprising:

two or more kinds of dots having different directions of slow axes.

(3) The optical element according to (1) or (2), further comprising:

an overcoat layer that is disposed on the support to cover the dots.

(4) The optical element according to (3),

in which an absolute value of a difference between a refractive index of the overcoat layer and an ordinary light refractive index of the liquid crystal compound is 0.2 or less.

(5) The optical element according to any one of (1) to (4),

in which the liquid crystal compound is a rod-shaped liquid crystal compound or a disk-shaped liquid crystal compound.

(6) The optical element according to any one of (1) to (5), which is used as a microlens array.

(7) A wearable display device comprising:

a display panel that includes a plurality of pixels and a pixel grid disposed between the plurality of pixels adjacent to each other;

an eyepiece for collecting light emitted from the display panel through the plurality of pixels; and

the optical element according to (6) that is disposed on an optical path of the display panel and the eyepiece.

According to the present invention, it is possible to provide an optical element that is suitably applicable to a wearable display device in which a pixel grid of a display panel is inconspicuous to a user and the generation of moire is suppressed.

In addition, according to the present invention, it is possible to provide a wearable display device including the above-described optical element.

### BRIEF DESCRIPTION OF THE DRAWINGS

FIG. 1 is a cross-sectional view illustrating a first embodiment of an optical element.

FIG. 2 is a partial top view illustrating the optical element of FIG. 1.

FIG. 3 is a cross-sectional view illustrating a dot for describing a function of the dot.

FIG. 4 is a cross-sectional view illustrating the dot for describing the function of the dot.

FIG. 5 is a top view illustrating the dot for describing the function of the dot.

FIG. 6 is a top view illustrating a second embodiment of the optical element.

FIG. 7 is a top view illustrating a third embodiment of the optical element.

FIG. 8 is a top view illustrating a fourth embodiment of the optical element.

FIG. 9 is a diagram illustrating a schematic configuration of a wearable display device.

FIG. 10 is a partial cross-sectional view illustrating a display panel and the optical element.

### DESCRIPTION OF THE PREFERRED EMBODIMENTS

Hereinafter, an embodiment of an optical element and a wearable display device according to the present invention will be described with reference to the drawings. In each of the drawings, for easy visual recognition, the reduced scale of components is different from the actual scale.

In this specification, numerical ranges represented by “to” include numerical values before and after “to” as lower limit values and upper limit values.

In this specification, for example, unless specified otherwise, an angle such as “45°”, “parallel”, or “perpendicular” represents that a difference from an exact angle is less than 5°. The difference from an exact angle is preferably less than 4° and more preferably less than 3°.

### First Embodiment

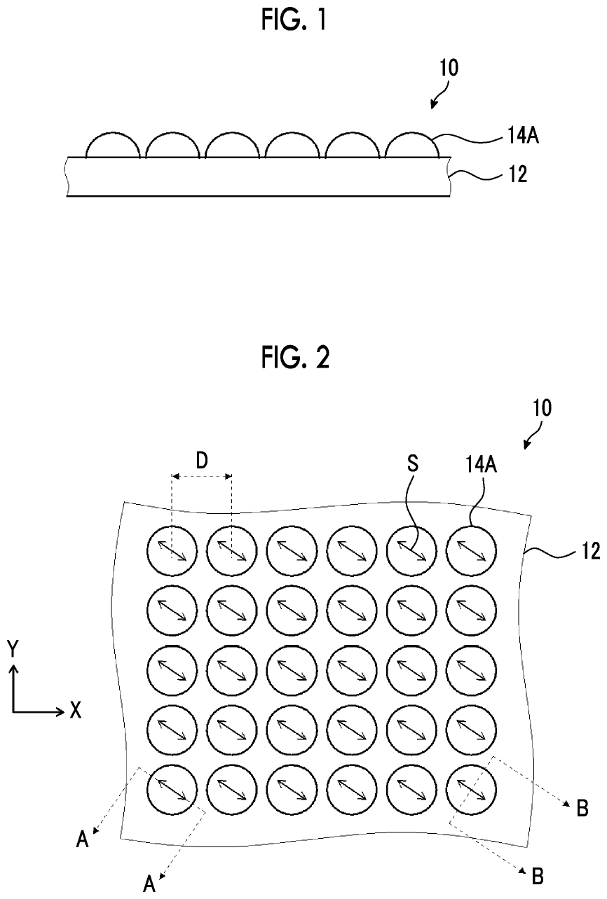

FIG. 1 is a cross-sectional view illustrating a first embodiment of an optical element according to the present invention. FIG. 2 is a top view illustrating the first embodiment of the optical element according to the present invention. For convenience of description, in FIG. 2, a left-right direction represents an X-axis direction, and an up-down direction represents a Y-axis direction.

The optical element 10 includes: a support 12; and a plurality of dots 14A that are arranged on the support 12. As illustrated in FIG. 2, in a plan view, the dots 14A are arranged in a grid shape in a direction parallel to the X-axis direction and the Y-axis direction. That is, examples of the direction in which the dots 14A are arranged include the X-axis direction and the Y-axis direction.

Each of the dots 14A exhibits optical anisotropy, and an arrow in FIG. 2 represents a slow axis S. In FIG. 2, the slow axes S of all the dots 14A are arranged parallel to each other. In other words, the slow axes S of all the dots 14A are arranged parallel to one in-plane direction.

In FIG. 2, the direction of the slow axes S of the dots 14A is at a position inclined clockwise by 45° from the X-axis direction. In addition, the direction of the slow axes S of the dots 14A is at a position inclined counterclockwise by 45° from the Y-axis direction. That is, the direction of the slow axes S of the dots 14A are different from the direction in which the dots 14A are arranged (the X-axis direction and the Y-axis direction). In other words, the optical element 10 comprises the dots 14A having a slow axis in a direction different from a direction in which the plurality of dots 14A are arranged.

Hereinafter, members constituting the optical element 10 will be described in detail. Next, a method of manufacturing the optical element 10 will be described in detail.

(Support)

The support is a member for supporting the dots.

As the support, a transparent support is preferable, and examples thereof include a polyacrylic resin film such as polymethyl methacrylate, a cellulose resin film such as cellulose triacetate, and a cycloolefin polymer film (for example, trade name “ARTON”, manufactured by JSR Corporation; or trade name “ZEONOR”, manufactured by Zeon Corporation).

The support is not limited to a flexible film and may be a non-flexible substrate such as a glass substrate.

“Transparent” described in this specification represents that the non-polarized light transmittance (total transmittance) at a wavelength of 380 to 780 nm is preferably 50% or higher, more preferably 70% or higher, and still more preferably 85% or higher.

(Dot)

The dot exhibits optical anisotropy and has the slow axis. The dot exhibiting optical anisotropy represents that birefringence is exhibited in an in-plane direction of the dot. The in-plane direction represents a direction parallel to the support surface.

The dot is formed of a composition including a liquid crystal compound. As described below, it is preferable that the dot is formed by immobilizing the alignment of the liquid crystal compound. The composition to be used and a method of forming the dot will be described below.

As described below, in FIG. 2, the slow axes of all the dots 14A are arranged along one direction, and the direction is different from the X-axis direction and the Y-axis direction as the directions in which the dots 14A are arranged. That is, the direction of the slow axes in the dots is different from the direction in which the dots are arranged. In other words, the direction of the slow axes in the dots is different from the direction (a vertical direction and a horizontal direction of a grid) in which a grid of the dots having a grid shape is arranged.

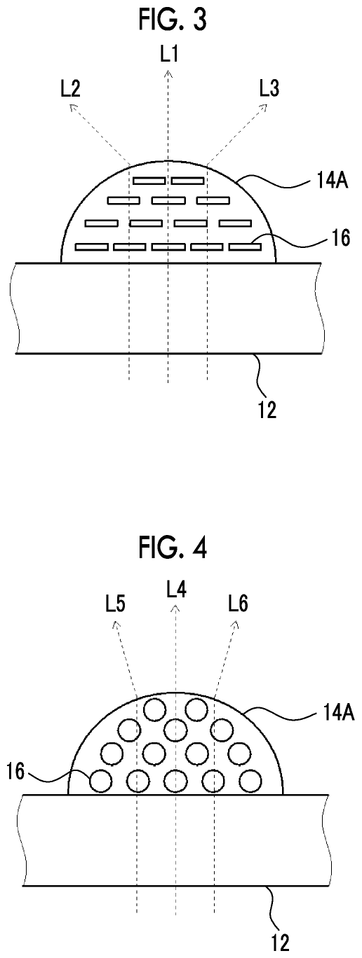

The function of the optical element including the dots arranged as described above will be described using FIGS. 3 to 5. In FIGS. 3 to 5, for convenience of description, a case in which the dots are formed of a composition including a rod-shaped liquid crystal compound is illustrated, and the rod-shaped liquid crystal compound in the dot is horizontally aligned.

FIG. 3 is a cross-sectional view in a case where the dot 14A is cut in a direction parallel to the slow axis in the dot 14A of FIG. 2. Specifically, FIG. 3 is a cross-sectional view taken along section line A-A in FIG. 2. In a cross-section of the dot 14A illustrated in FIG. 3, the cross-sectional surface and a major axis direction of the rod-shaped liquid crystal compound 16 are parallel to each other.

Light components emitted through a plurality of pixels in a display panel included in a wearable display device described below are incident from the support side of the optical element. As illustrated in FIG. 3, among the light components incident from the support 12 side, a light component L1 incident into the vicinity of center of the dot 14A advances linearly as it is in a direction parallel to the incidence direction.

On the other hand, light components L2 and L3 incident into positions deviating from the vicinity of the center of the dot 14A are bent on the surface of the dot 14A due to a difference in refractive index between the dot 14A and the air. That is, each of the light components L2 and L3 incident into the dot 14A is emitted in a direction inclined by a predetermined angle from the incident direction. In particular, the cross-section part obtained by cutting the dot in a direction parallel to the slow axis in the dot 14A illustrated in FIG. 3 has a refractive index that is substantially the same as an extraordinary light refractive index of the liquid crystal compound. Therefore, a difference in refractive index between the dot 14A and the air is large, and the angle by which each of the light components L2 and L3 is bent is large.

On the other hand, FIG. 4 is a cross-sectional view in a case where the dot 14A is cut in a direction perpendicular to the slow axis in the dot 14A of FIG. 2. Specifically, FIG. 4 is a cross-sectional view taken along section line B-B in FIG. 2. In a cross-section of the dot 14A illustrated in FIG. 3, the cross-sectional surface and a major axis direction of the rod-shaped liquid crystal compound 16 are perpendicular to each other.

As illustrated in FIG. 4, among the light components incident from the support 12 side, a light component L4 incident into the vicinity of center of the dot 14A advances linearly as it is in a direction parallel to the incidence direction. On the other hand, light components L5 and L6 incident into positions deviating from the vicinity of the center of the dot 14A are bent on the surface of the dot 14A due to a difference in refractive index between the dot 14A and the air.

In particular, the cross-section part obtained by cutting the dot 14A in a direction perpendicular to the slow axis in the dot 14A illustrated in FIG. 4 has a refractive index that is substantially the same as an ordinary light refractive index of the liquid crystal compound. Therefore, a difference in refractive index between the dot 14A and the air is less than that of FIG. 3. As a result, the angle by which each of the light components L5 and L6 is bent is less than the angle by which each of the light components L2 and L3 in FIG. 3 is bent.

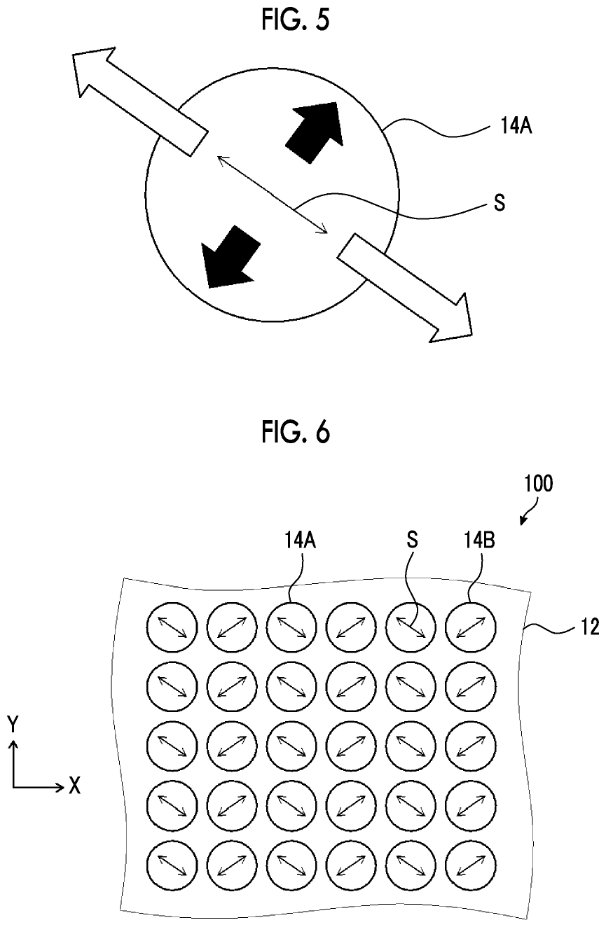

Therefore, in a case where the light incident from the support 12 side of the optical element 10 is emitted through the dot 14A, a method in which the light is bent in a direction parallel to the slow axis S and a method in which the light is bent in a direction perpendicular to the slow axis S are different from each other as illustrated in FIG. 5 that is a top view illustrating the dot 14A. That is, the light is emitted in a wide range in the direction parallel to the slow axis S as indicated by white arrows in FIG. 5, and the light is emitted in a narrower range in the direction perpendicular to the slow axis S than that of the direction parallel to the slow axis S as indicated by black arrows in FIG. 5.

As described above, the spreading of the light emitted from the dot 14A has anisotropy. By arranging the slow axes A of the dots 14A having the above-described characteristics in a direction different from the direction in which the dots 14A are arranged, interference generated in a case where the optical element and the display panel are laminated is suppressed, and thus moire is reduced.

An arrangement pattern of the dots is not particularly limited, and an optimum arrangement is appropriately selected depending on a pixel arrangement in the display panel. Examples of the arrangement pattern include a grid shape illustrated in FIG. 2 and a hexagonal close-packed shape.

An arrangement density of the dots is not particularly limited and is appropriately selected depending on a pixel arrangement in the display panel.

Typically, in a case where the dots are seen from a normal direction of a main surface of the support, an area ratio of the dots to the support is preferably 5% to 100% and more preferably 10% to 95%.

The area ratio of the dots is obtained by obtaining an image using a microscope such as a laser microscope or a scanning electron microscope (SEM), measuring area ratios in a region having a size of 1 mm×1 mm, and obtaining an average value of area ratios at five positions.

It is preferable that the dot is circular in case of being seen from the normal direction of the main surface of the support.

The circular shape is not necessarily a perfect circle and may be a substantially circular shape. The center of the dot described herein refers to the center of the circle or the center of gravity. The dots are not particularly limited as long as the average shape of the dots is circular, and may include some dots having a shape other than a circular shape.

In addition, the dots may have a shape such as a hemispherical shape (substantially hemispherical shape), a spherical segment shape (substantially spherical segment shape), a spherical trapezoidal shape, a conical shape, or a truncated cone shape.

An inter-center distance (D in FIG. 2) of the dots is not particularly limited and is appropriately selected depending on a pixel arrangement in the display panel.

The inter-center distance of the dots is preferably 1 to 150 μm and more preferably 5 to 100 μm.

The height of the dot is not particularly limited and is preferably 0.1 to 50 μm and more preferably 0.5 to 30 μm.

The height of the dot can be obtained from a cross-sectional view of the dot which is obtained by focal position scanning using a laser microscope or obtained using a microscope such as a SEM.

The diameter of the dot is not particularly limited and is preferably 1 to 150 μm and more preferably 5 to 100 μm.

As described above, the dot is formed of a composition including a liquid crystal compound.

Hereinafter, components included in the composition will be described in detail, and then a method of forming the dot will be described in detail.

Examples of the liquid crystal compound include a rod-shaped liquid crystal compound and a disk-shaped liquid crystal compound.

Examples of the rod-shaped liquid crystal compound include an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, and an alkenylcyclohexylbenzonitrile compound. Not only the above-described low-molecular-weight liquid crystal compound but also a high-molecular-weight liquid crystal compound can be used.

Examples of the rod-shaped liquid crystal compound include compounds described in Makromol. Chem. (1989), Vol. 190, p. 2255, Advanced Materials (1993), Vol. 5, p. 107, U.S. Pat. Nos. 4,683,327A, 5,622,648A, 5,770,107A, WO95/022586A, WO95/024455A, WO97/000600A, WO98/023580A, WO98/052905A, JP1989-272551A (JP-H1-272551A), JP1994-016616A (JP-H6-016616A), JP1995-110469A (JP-H7-110469A), JP1999-080081A (JP-H11-080081A), and JP2001-064627A.

Examples of the disk-shaped liquid crystal compound include compounds described in JP2007-108732A and JP2010-244038A.

It is preferable that the liquid crystal compound has a polymerizable group. As the polymerizable group, an unsaturated polymerizable group, an epoxy group, or an aziridinyl group is preferable, an unsaturated polymerizable group is more preferable, and an ethylenically unsaturated polymerizable group is still more preferable.

The content of the liquid crystal compound in the composition is not particularly limited and is preferably 75 to 99.9 mass % and more preferably 80 to 99 mass % with respect to the total solid content in the composition.

As the liquid crystal compound, one kind may be used alone, or a combination of two or more kinds may be used.

The composition may include a component other than the liquid crystal compound.

For example, the composition may include a surfactant. Examples of the surfactant include a silicone surfactant and a fluorine surfactant.

The content of the surfactant in the composition is preferably 0.01 to 10 mass % and more preferably 0.01 to 5 mass % with respect to the total mass of the liquid crystal compound.

As the surfactant, one kind may be used alone, or two or more kinds may be used in combination.

The composition may include a polymerization initiator. As the polymerization initiator, a photopolymerization initiator is preferable, and a photopolymerization initiator that can initiate a polymerization reaction by ultraviolet irradiation is more preferable.

The content of the photopolymerization initiator in the composition is preferably 0.1 to 20 mass % and more preferably 0.5 to 12 mass % with respect to the content of the liquid crystal compound.

The composition may include a solvent. As the solvent, an organic solvent is preferable.

The content of the solvent in the composition is preferably 20 to 99 mass % with respect to the total mass of the composition.

In addition, the composition may optionally further include an alignment controller, a polymerizable compound, a polymerization inhibitor, an antioxidant, an ultraviolet absorber, a light stabilizer, a coloring material, and metal oxide particles.

The method of forming the dot is not particularly limited, and examples thereof include: a method of applying a composition including a polymerizable liquid crystal compound to the support in a dot shape and curing the composition; a method of uniformly applying a composition including a polymerizable liquid crystal compound to the support, pressing the composition with a mold having a state where the dot portion is recessed, and curing the composition; and a method of applying a composition including a polymerizable liquid crystal compound to a mold having a state where the dot portion is recessed and curing the composition.

Hereinafter, the procedure of the method of applying a composition including a polymerizable liquid crystal compound to the support in a dot shape and curing the composition will be described in detail.

First, as the method of applying the composition to the support, an ink jet method (jetting of the composition) or a printing method is preferable. The kind of the printing method is not particularly limited, and examples thereof include a gravure printing method, a flexographic printing method, and a screen printing method. In particular, an ink jet method is preferable from the viewpoint of easily adjusting the jetting amount of ink droplets and/or jetting positions of ink droplets.

The composition applied to the support is optionally dried or heated and then is cured to form the dot.

In the drying and/or heating step, the liquid crystal compound in the composition only has to be aligned. In the case of heating, the heating temperature is preferably 200° C. or lower and more preferably 130° C. or lower.

It is preferable that the aligned liquid crystal compound is further polymerized and immobilized. Regarding the polymerization, thermal polymerization or photopolymerization using light irradiation may be performed, and photopolymerization is preferable. Regarding the light irradiation, ultraviolet light is preferably used. The irradiation energy is preferably 100 to 1,500 mJ/cm². In order to promote a photopolymerization reaction, light irradiation may be performed under heating conditions or in a nitrogen atmosphere.

(Other Members)

The optical element may include other members other than the support and the dots.

For example, the optical element may further include an alignment film between the support and the dots. The alignment film is a film having an alignment restriction force of adjusting the direction of the slow axes of the dots formed thereon.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound. The rubbing treatment is performed by rubbing a surface of a polymer layer with paper or fabric in a given direction multiple times.

In addition, examples of the alignment film include a so-called photo-alignment film obtained by irradiating a photo-alignable material with polarized light or non-polarized light.

Further, an optically-anisotropic layer itself that is formed of the composition including the liquid crystal compound may be used as the alignment film.

The alignment film may have a single-layer structure or a multi-layer structure. In the case of the multi-layer structure, for example, an aspect including a photo-alignment film and another alignment film (for example, an optically-anisotropic layer) disposed on the photo-alignment film may be adopted.

In addition, the optical element may further include an overcoat layer that is disposed on the support to cover the dots. By disposing the overcoat layer, the spreading of outgoing light in the slow axis direction of the dots and the spreading of outgoing light in the direction in which the dots are arranged can be more accurately controlled. In addition, the shape of the dots from the outside can be protected.

In addition, an absolute value of a difference between a refractive index of the overcoat layer and an ordinary light refractive index of the liquid crystal compound is not particularly limited and, from the viewpoint of further suppressing the generation of moire, is preferably 0.2 or less and more preferably 0.1 or less. The lower limit is not particularly limited and, for example, 0.

The refractive index of the overcoat layer and the ordinary light refractive index of the liquid crystal compound are refractive indices at a wavelength of 589 nm.

The thickness of the overcoat layer is not particularly limited and is preferably 0.1 to 50 μm and more preferably 0.5 to 30 μm.

A method of forming the overcoat layer is not particularly limited, and examples thereof include a method including: applying an overcoat layer-forming composition including a polymerizable compound to the support on which the dots are arranged and curing the composition.

### Second Embodiment

FIG. 6 is a top view illustrating a second embodiment of the optical element according to the present invention.

An optical element 100 includes: the support 12; and a plurality of dots 14A and a plurality of dots 14B that are arranged on the support 12.

The optical element 100 has the same configuration as that of the optical element 10 according to the first embodiment, except that two kinds of dots having different directions of slow axes are provided. Therefore, the same components as those of the first embodiment will be represented by the same reference numerals, and the description thereof will not be repeated.

In addition, the configurations of the dots 14A and the dots 14B are the same except that the directions of the slow axes are different.

That is, the optical element 100 and the optical element 10 are only different in that the directions in which the slow axes in the dots are arranged are different.

In the optical element 100, the slow axes in the dots 14A and the slow axes in the dots 14B are perpendicular to each other.

In addition, in FIG. 6, the direction of the slow axes S of the dots 14A is at a position inclined clockwise by 45° from the X-axis direction. In addition, the direction of the slow axes S of the dots 14A is at a position inclined counterclockwise by 45° from the Y-axis direction. That is, the direction of the slow axes S of the dots 14A are different from the direction in which the dots 14A are arranged (the X-axis direction and the Y-axis direction).

Further, in FIG. 6, the direction of the slow axes S of the dots 14B is at a position inclined counterclockwise by 45° from the X-axis direction. In addition, the direction of the slow axes S of the dots 14A is at a position inclined clockwise by 45° from the Y-axis direction. That is, the direction of the slow axes S of the dots 14B are different from the direction in which the dots 14B are arranged (the X-axis direction and the Y-axis direction).

By providing the two kinds of dots having different directions of slow axes, the generation of moire is further suppressed as compared to the first embodiment.

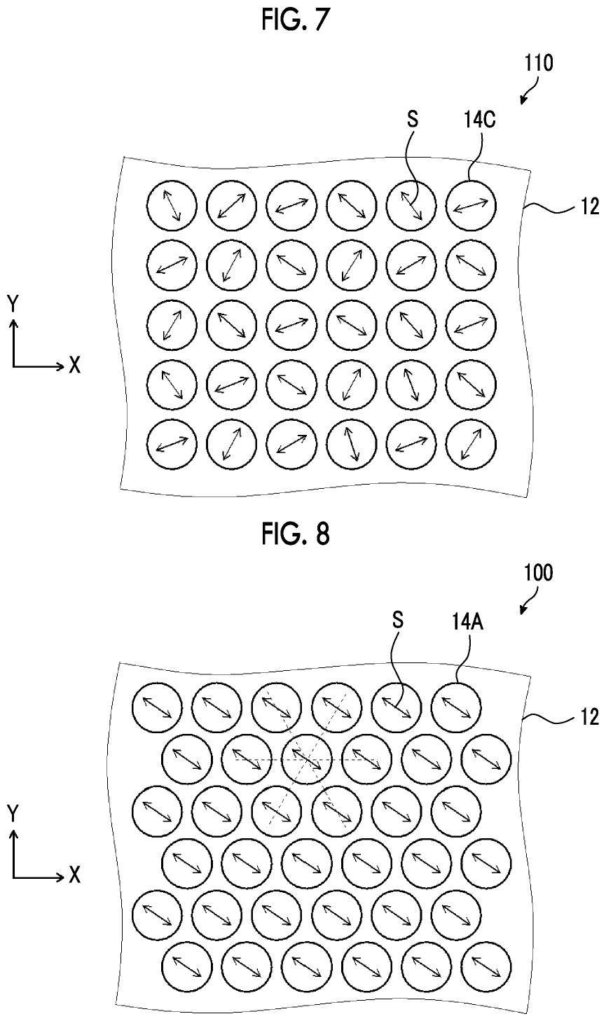

In the first embodiment, only the dots in which the directions of the slow axes are aligned with one direction are provided. In the second embodiment, only the dots in which the directions of the slow axes are aligned with two directions are provided. However, the present invention is not limited to these embodiments. That is, an optical element including three or more kinds of dots having different directions of slow axes or an optical element 110 according to a third embodiment including dots 14C having random directions of slow axes as illustrated in FIG. 7 may be adopted. In particular, in the case of the optical element including two or more kinds of dots having different directions of slow axes, the generation of moire is further suppressed.

In addition, the optical element according to the embodiment of the present invention includes dots (hereinafter, also referred to as “dots X”) having a slow axis of which a direction is different from the direction in which the plurality of dots are arranged. In particular, the number of the dots X is preferably 50% or higher, more preferably 70% or higher, and still more preferably 100% with respect to all the dots.

### Fourth Embodiment

FIG. 8 is a top view illustrating a fourth embodiment of the optical element according to the present invention.

An optical element 120 includes: the support 12; and a plurality of dots 14A that are arranged on the support 12. As illustrated in FIG. 10, in a plan view, the dots 14A are arranged in a hexagonal close-packed shape in directions inclined by ±60° from a direction parallel to the X-axis direction and from the X-axis. That is, examples of the direction in which the dots 14A are arranged include the directions inclined by ±60° from the X-axis direction and from the X-axis. In other words, examples of the direction in which the dots 14A are arranged include three directions including one direction that connects one dot 14A and another one of six dots 14A adjacent to the dot 14A, a direction inclined clockwise by 60° from the above-described direction, and a direction inclined counterclockwise by 60° from the above-described direction.

The optical element 120 has the same configuration as that of the optical element 10 according to the first embodiment, except that the directions in which the dots are arranged are different. Therefore, the same components as those of the first embodiment will be represented by the same reference numerals, and the description thereof will not be repeated.

<Use>

The optical element is suitably applicable to various uses, and examples of the uses include a diffuser for a head-up display of an automobile ad a microlens array for a three-dimensional display.

In particular, the optical element according to the embodiment of the present invention is suitably applicable to a microlens array included in a wearable display device.

Hereinafter, the wearable display device including the optical element will be described in detail.

<Wearable Display Device>

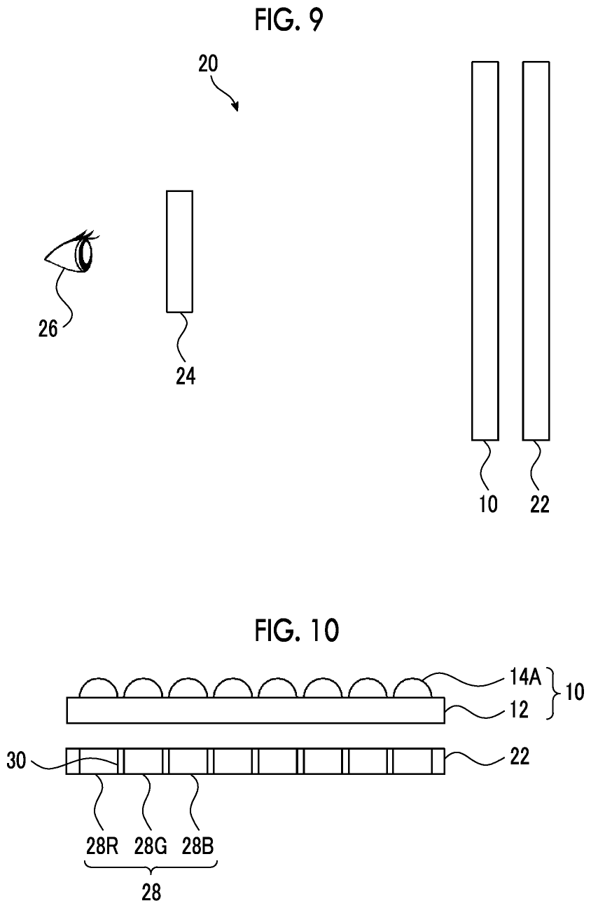

FIG. 9 is a diagram illustrating a schematic configuration of a wearable display device according to an embodiment of the present invention.

A wearable display device 20 includes: a display panel 22 for displaying an image; an eyepiece 24 for collecting light emitted from the display panel 22; and the optical element 10 that is disposed between the display panel 22 and the eyepiece 24 (on an optical path thereof). In a case where a user uses the wearable display device 20, the eyepiece 24 is disposed in the very vicinity of an eye 26 of the user. Therefore, an image that is displayed on the display panel 22 and is enlarged by the eyepiece 24 is visually recognized by the user.

FIG. 10 is a cross-sectional view illustrating the display panel 22 and the optical element 10. As illustrated in FIG. 10, the display panel 22 includes a plurality of pixels 28 and a pixel grid 30 disposed between the plurality of pixels 28 adjacent to each other. The plurality of pixels 28 includes a plurality of red pixels 28R, a plurality of green pixels 28G, and a plurality of blue pixels 28B. The display panel 22 emits light toward the optical element 10 through the plurality of pixels 28.

The size and arrangement pattern of the dots in the optical element 10 can be appropriately adjusted depending on the size and arrangement pattern of the pixels in the display panel.

In a case where the optical element 10 and the display panel 22 are laminated, it is preferable that the arrangement direction of the dots 14A in the optical element 10 and the pixel arrangement direction in the display panel 22 match each other.

In addition, as illustrated in FIG. 10, it is preferable that the optical element 10 is disposed on the display panel 22 such that the dots 14A of the optical element 10 correspond to the pixels 28 of the display panel 22. That is, it is preferable that the optical element 10 is disposed on the display panel 22 such that center positions of the dots 14A of the optical element 10 match center positions of the pixels 28 of the display panel 22.

As described above, in the optical element 10, the pixel grid of the display panel is inconspicuous to the user as in the microlens array. Further, by adjusting the slow axes of the dots 14A in the optical element 10, the generation of moire is suppressed even in a case where the arrangement direction of the dots in the optical element matches the pixel arrangement direction in the display panel.

### EXAMPLES

Hereinafter, the present invention will be described in detail using examples. Materials, reagents, proportions thereof, operations, and the like shown in the following Examples can be appropriately changed as long as they do not depart from the scope of the present invention. Accordingly, the scope of the present invention is not limited to the following specific examples.

### Example 1

(Saponification of Support)

As the support, a commercially available triacetyl cellulose “Z-TAC” (manufactured by Fuji Film Co., Ltd.) was used. The support was caused to pass through an induction heating roll at a temperature of 60° C. such that the support surface temperature was increased to 40° C. Next, an alkali solution shown below was applied to a single surface of the support using a bar coater in an application amount of 14 mL/m², the support was heated to 110° C., and the support was transported for 10 seconds under a steam infrared electric heater (manufactured by Noritake Co., Ltd.). Next, 3 mL/m² of pure water was applied to the support surface using the same bar coater. Next, water cleaning using a foundry coater and water draining using an air knife were repeated on the obtained support three times, and then the support was transported and dried in a drying zone at 70° C. for 10 seconds. As a result, the support having undergone the alkali saponification treatment was obtained.

(Alkali Solution)

| | | |
|---|---|---|
| Potassium hydroxide | 4.70 | parts by mass |
| Water | 15.80 | parts by mass |
| Isopropanol | 63.70 | parts by mass |
| Surfactant | 1.0 | part by mass |
| (C₁₄H₂₉O(CH₂CH₂O)₂H) | | |
| Propylene glycol | 14.8 | parts by mass |

(Formation of Undercoat Layer)

The following undercoat layer-forming coating solution was continuously applied to the support having undergone the alkali saponification treatment using a #8 wire bar. The support on which the coating film was formed was dried using warm air at 60° C. for 60 seconds and was dried using warm air at 100° C. for 120 seconds. As a result, an undercoat layer was formed.

(Undercoat Layer-Forming Coating Solution)

| | |
|---|---|
| The following modified polyvinyl alcohol | 2.40 parts by mass |
| Isopropyl alcohol | 1.60 parts by mass |
| Methanol | 36.00 parts by mass |
| Water | 60.00 parts by mass |

Modified Polyvinyl Alcohol

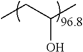

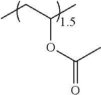

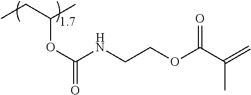

(Formation of Photo-Alignment Film)

The following photo-alignment film-forming coating solution was continuously applied to the support on which the undercoat layer was formed using a #2 wire bar. The obtained support was dried using warm air at 60° C. for 60 seconds to form a coating film.

The coating film formed as described above was exposed to ultraviolet light at an exposure dose of 100 mJ/cm² through a wire grid polarizing plate of which a transmission axis is inclined by 45° from a longitudinal direction of the film. As a result, a photo-alignment film was formed.

(Photo-Alignment Film-Forming Coating Solution)

| | |
|---|---|
| The following material for photo-alignment | 1.00 part by mass |
| Water | 16.00 parts by mass |
| Butoxyethanol | 42.00 parts by mass |
| Propylene glycol monomethyl ether | 42.00 parts by mass |

Material for Photo-Alignment-

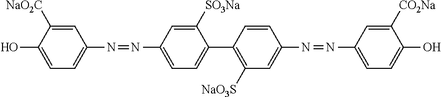

(Formation of Alignment Film)

In a container held at 25° C., the following components were mixed with each other to prepare an alignment film-forming coating solution.

(Alignment Film-Forming Coating Solution)

| | |
|---|---|
| Mixture of the following rod-shaped liquid crystal | 100.0 parts by mass |
| compounds | |
| IRGACURE 819 (manufactured by BASF SE) | 3.0 parts by mass |
| The following compound A | 0.6 parts by mass |
| Methyl ethyl ketone | 932.4 parts by mass |

Rod-Shaped Liquid Crystal Compounds

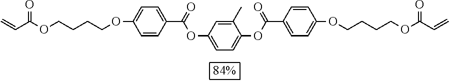 [SMILES: C=CC(=O)OCCCCOc1ccc(C(=O)Oc2ccc(OC(=O)c3ccc(OCCCCOC(=O)C=C)cc3)c(C)c2)cc1]

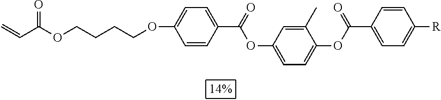

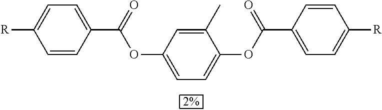

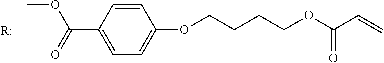

Numerical values are represented by mass %. In addition, R represents a group to be bonded to oxygen.

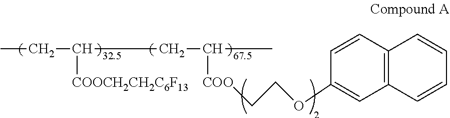

The alignment film-forming coating solution was applied to the photo-alignment film using a #2.6 bar coater. Next, the coating film was heated such that the film surface temperature was 95° C., and then was dried for 60 seconds. Next, in a nitrogen purged atmosphere having an oxygen concentration of 100 ppm or lower, the coating film was irradiated with ultraviolet light at 500 mJ/cm² using an ultraviolet irradiation device to promote a crosslinking reaction. As a result, an alignment film was formed.

(Formation of Dot)

In a container held at 25° C., the following components were mixed with each other to prepare a liquid crystal ink solution LI-1.

(Liquid Crystal Ink Solution LI-1)

| | |
|---|---|
| Cyclopentanone | 132.5 parts by mass |
| Mixture of the above-described rod-shaped liquid crystal compounds | 100.0 parts by mass |
| IRGACURE 907 (manufactured by BASF SE) | 3.0 parts by mass |
| KAYACURE DETX (manufactured by Nippon Kayaku Co., Ltd.) | 1.0 part by mass |
| Surfactant having the following structure | 0.08 parts by mass |

Surfactant

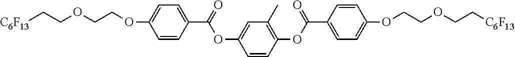

Using an ink jet printer (DMP-2831, manufactured by Fujifilm Dimatix Inc.), the liquid crystal ink solution LI-1 was jetted to the alignment film to form a grid-shaped pattern (refer to FIG. 2) having an inter-dot center distance of 30 μm, and then was dried at 60° C. for 60 seconds or longer. Next, using an ultraviolet irradiation device, the dot-shaped coating film was irradiated with ultraviolet light at 500 mJ/cm² at room temperature and was cured. As a result, an optical element 1 was prepared.

As illustrated in FIG. 2, a direction of slow axes in the formed dots was at a position inclined counterclockwise by 45° from the vertical direction (Y-axis direction) in which the dots are arranged and inclined clockwise by 45° from the horizontal direction (X-axis direction) in which the dots are arranged. In addition, the diameter of the dots was 20 μm, the height of the dots was 3 μm, and the area ratio of the dots was 35%.

### Example 2

The coating film of the photo-alignment film-forming coating solution prepared using the same method as that of Example 1 was irradiated with ultraviolet light at an exposure dose of 100 mJ/cm² through a wire grid polarizing plate of which a transmission axis was inclined by 45 degrees from a longitudinal direction of the film and a strip-shaped photomask having L/S=30 μm/30 μm.

Next, after shifting the photomask by 30 μm, a portion that was not exposed in the above process was irradiated with ultraviolet light at an exposure dose of 100 mJ/cm² through a wire grid polarizing plate of which a transmission axis was inclined by 135 degrees from a longitudinal direction of the film and a strip-shaped photomask having L/S=30 μm/30 μm.

An optical element 2 was prepared using the same method as that of Example 1 except for the above-described configuration.

As illustrated in FIG. 6, the optical element 2 includes two kinds of dots having different directions of slow axes. The direction of the slow axes in one kind of dots was at a position inclined counterclockwise by 45° from the vertical direction (Y-axis direction) in which the dots are arranged and inclined clockwise by 45° from the horizontal direction (X-axis direction) in which the dots are arranged. The direction of the slow axes in another kind of dots was at a position inclined clockwise by 45° from the vertical direction (Y-axis direction) in which the dots are arranged and inclined counterclockwise by 45° from the horizontal direction (X-axis direction) in which the dots are arranged.

### Example 3

An overcoat layer-forming composition having the following composition was applied to the optical element 2 to cover the dots of the optical element 2 formed in Example 2 and was dried at 50° C. for 1 minute. Next, using an ultraviolet irradiation device, the coating film was irradiated with ultraviolet light at 500 mJ/cm² at room temperature and was cured. As a result, an optical element 3 including the overcoat layer was prepared.

In addition, a refractive index of the overcoat layer was 1.48, an ordinary light refractive index of the rod-shaped liquid crystal compound was 1.51, and an absolute value of a difference between the refractive index of the overcoat layer and the ordinary light refractive index of the rod-shaped liquid crystal compound was 0.03.

The ordinary light refractive index of the rod-shaped liquid crystal compound was measured using an Abbe refractometer by separately preparing an optical film for measuring a refractive index using the liquid crystal ink solution LI-1. Specifically, the optical film for measuring a refractive index was prepared as follows. An undercoat layer was formed on high refractive index glass using the same method as described above, a rubbing treatment was performed, and the liquid crystal ink solution LI-1 was applied such that the thickness after drying was 10 μm. Next, the high refractive index glass on which the coating film was disposed was dried at 95° C. for 180 seconds. Next, in a nitrogen purged atmosphere having an oxygen concentration of 100 ppm or lower, the coating film was irradiated with ultraviolet light at 500 mJ/cm² using an ultraviolet irradiation device to promote a crosslinking reaction. As a result, the optical film for measuring a refractive index was formed.

(Overcoat Layer-Forming Composition)
In a container held at 25° C., the following components were mixed with each other to
prepare an overcoat layer-forming composition.

| | |
|---|---|
| Methyl ethyl ketone | 103.5 parts by mass |
| KAYARAD DPCA-30 (manufactured by Nippon Kayaku Co., Ltd.) | 100.0 parts by mass |
| The following compound A | 0.5 parts by mass |
| IRGACURE 127 (manufactured by BASF SE) | 3.0 parts by mass |

Compound A

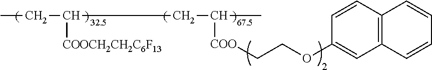

### Example 4

An optical element 4 was prepared using the same method as that of Example 1, except that the following liquid crystal ink solution LI-2 was used instead of the liquid crystal ink solution LI-1.

(Liquid Crystal Ink Solution LI-2)

| | |
|---|---|
| The following liquid crystal compound L-1 | 42.00 parts by mass |
| The following liquid crystal compound L-2 | 42.00 parts by mass |
| The following liquid crystal compound L-3 | 16.00 parts by mass |
| The following polymerization initiator PI-1 | 0.50 parts by mass |
| The following leveling agent T-1 | 0.50 parts by mass |
| Cyclopentanone | 220.00 parts by mass |

Liquid Crystal Compound L-1- 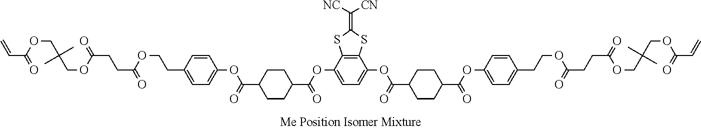 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Liquid Crystal Compound L-2- 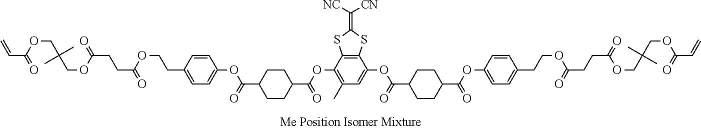 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Liquid Crystal Compound L-3- 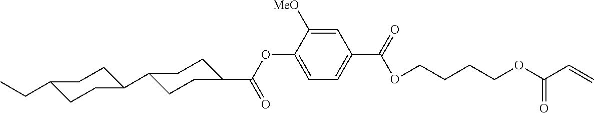 [SMILES: C=CC(=O)OCCCCOC(=O)c1ccc(OC(=O)C2CCC(C3CCC(CC)CC3)CC2)c(OC)c1]
Polymerization initiator PI-1- 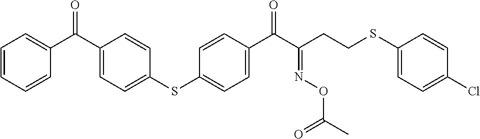 [SMILES: CC(=O)O/N=C(\CCSc1ccc(Cl)cc1)C(=O)c1ccc(Sc2ccc(C(=O)c3ccccc3)cc2)cc1]
Leveling Agent T-1-

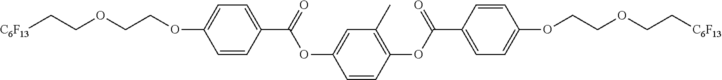

### Example 5

An optical element 5 was prepared using the same method as that of Example 1, except that the following liquid crystal ink solution LI-3 was used instead of the liquid crystal ink solution LI-1.

(Liquid Crystal Ink Solution LI-3)

| | |
|---|---|
| Discotic liquid crystal E-1 | 80 parts by mass |
| Discotic liquid crystal 2 | 20 parts by mass |
| Ethylene oxide-modified trimethylolpropane | 10 parts by mass |
| triacrylate (V#360, manufactured by Osaka | |
| Organic Chemical Industry Ltd.) | |
| Photopolymerization initiator (IRGACURE 819, | 6.0 parts by mass |
| manufactured by BASF SE) | |
| Vertical alignment agent (S01) | 8.26 parts by mass |
| Vertical alignment agent (S02) | 0.73 parts by mass |
| Fluorine-containing compound A | 1.0 part by mass |
| Fluorine-containing compound B | 0.4 parts by mass |
| Methyl ethyl ketone | 2401 parts by mass |

Discotic Liquid Crystal E-1 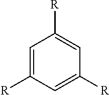 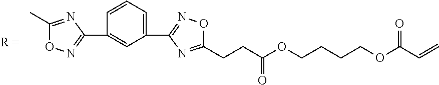 [SMILES: C=CC(=O)OCCCCOC(=O)CCc1nc(-c2cccc(-c3noc(C)n3)c2)no1]
Discotic Liquid Crystal 2 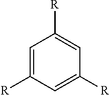 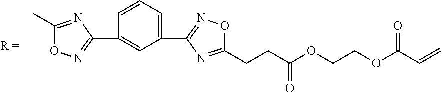 [SMILES: C=CC(=O)OCCOC(=O)CCc1nc(-c2cccc(-c3noc(C)n3)c2)no1]
Vertical Alignment Agent (S01) 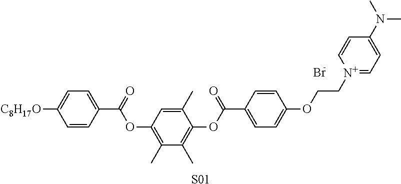
Vertical Alignment Agent (S02) 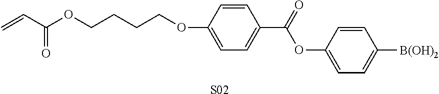 [SMILES: C=CC(=O)OCCCCOc1ccc(C(=O)Oc2ccc(B(O)O)cc2)cc1 ; "S02"]
Fluorine-Containing Compound A 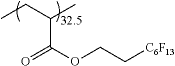 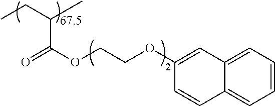
Fluorine-Containing Compound B

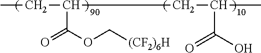

### Example 6

An optical element 6 was prepared using the same method as that of Example 2, except that the following liquid crystal ink solution LI-3 was used instead of the liquid crystal ink solution LI-1.

### Comparative Example 1

Playstation VR (manufactured by Sony Interactive Entertainment Inc.) was disassembled, and a sheet (microlens array) bonded to a display portion was removed. In this state, Playstation VR was assembled again. An image was displayed and was observed through a lens to perform <Evaluation> described below.

### Comparative Example 2

Playstation VR (manufactured by Sony Interactive Entertainment Inc.) was disassembled, and an image was displayed without removing a sheet (microlens array) bonded to a display portion and was observed through a lens to perform <Evaluation> described below.

<Evaluation>

Playstation VR (manufactured by Sony Interactive Entertainment Inc.) was disassembled, and a sheet (microlens array) bonded to a display portion was removed. Next, each of the optical elements 1 to 6 according to Examples was bonded to the display portion. At this time, surfaces on the support side were bonded through a pressure sensitive adhesive. After assembling Playstation VR again, an image was displayed and was observed through a lens to perform <Evaluation> described below.

(Pixel Grid Visibility)

By using a white solid image as the image to be displayed on the image display portion, the pixel grid was observed by visual inspection, and evaluation was performed based on the following four grades.

A: the pixel grid was not visually recognized

B: the pixel grid was visually recognized, but the degree thereof was small

C: the pixel grid was visually recognized, but the degree thereof was in an allowable range

D: the pixel grid was clearly visually recognized

(Moire)

By using a white solid image as the image to be displayed on the image display portion, moire was observed by visual inspection, and evaluation was performed based on the following four grades.

A: the moire was not visually recognized

B: the moire was visually recognized, but the degree thereof was small

C: the moire was visually recognized, but the degree thereof was in an allowable range

D: the moire was conspicuous

In the item “Liquid Crystal Compound” of Table 1, “R1” and “R2” represent rod-shaped liquid crystal compounds, respectively, and “D” represents a disk-shaped liquid crystal compound.

In addition, in the item “Alignment Pattern of Slow Axes of Dots”, “FIG. 2” represents the arrangement state of the dots and the alignment state of the slow axes are as illustrated in FIG. 2, and “FIG. 6” represents the arrangement state of the dots and the alignment state of the slow axes are as illustrated in FIG. 6.

In addition, the item “Whether or Not OC Layer is Provided” represents whether or not the overcoat layer was provided, “Not Provided” represents that the overcoat layer was not provided, and “Provided” represents that the overcoat layer was provided.

TABLE 1

| | | | | | | | | Comparative | Comparative |
|---|---|---|---|---|---|---|---|---|---|
| | | Example 1 | Example 2 | Example 3 | Example 4 | Example 5 | Example 6 | Example 1 | Example 2 |
| Optical | Kind | 1 | 2 | 3 | 4 | 5 | 6 | None | Microlens |
| element | | | | | | | | | Array |
| | Liquid Crystal | R1 | R1 | R1 | R2 | D | D | — | — |
| | Compound | | | | | | | | |
| | Alignment Pattern | FIG. 2 | FIG. 6 | FIG. 6 | FIG. 2 | FIG. 2 | FIG. 6 | — | — |
| | of Slow Axes of | | | | | | | | |
| | Dots | | | | | | | | |
| | Whether OC Layer | Not | Not | Provided | Not | Not | Not | — | — |
| | is Provided | Provided | Provided | | Provided | Provided | Provided | | |
| Evaluation | Pixel Grid Visibility | A | A | A | A | A | A | D | A |
| | Moire | C | B | A | C | C | B | A | D |

As shown in Table 1, by using the optical element according to the embodiment of the present invention, the desired effects were obtained.

In particular, it was found from Examples 2 and 6 that, in a case where two or more kinds of dots having different directions of slow axes are provided, the effects are higher.

In addition, it was found from a comparison between Examples 2 and 3 that, by providing the overcoat layer, the effects are higher.

Next, samples according to Examples 7 and 8 were prepared using the same methods as those of Examples 2 and 3, except that the ink solution was jetted to form a hexagonal close-packed pattern (refer to FIG. 8) having an inter-dot center distance of 30 μm. The results of the evaluation of the pixel grid visibility and moire were the same as those of Examples 2 and 3.

### EXPLANATION OF REFERENCES

10, 100, 110, 120: optical element
12: support
14A, 14B, 14C: dot
16: rod-shaped liquid crystal compound
20: wearable display device
22: display panel
24: eyepiece
26: eye of user
28: pixel
28R: red pixel
28G: green pixel
28B: blue pixel
30: pixel grid

What is claimed is:

1. An optical element comprising:
a support; and
a plurality of dots that are arranged on the support and exhibit optical anisotropy,
wherein the dots are formed of a composition including a liquid crystal compound,
the optical element comprises the dots having a slow axis in a direction different from a direction in which the plurality of dots are arranged, and
the optical element is used as a microlens array.

2. The optical element according to claim 1, comprising:
two or more kinds of dots having different directions of slow axes.

3. The optical element according to claim 1, further comprising:
an overcoat layer that is disposed on the support to cover the dots.

4. The optical element according to claim 3,
wherein an absolute value of a difference between a refractive index of the overcoat layer and an ordinary light refractive index of the liquid crystal compound is 0.2 or less.

5. The optical element according to claim 1,
wherein the liquid crystal compound is a rod-shaped liquid crystal compound or a disk-shaped liquid crystal compound.

6. A wearable display device comprising:
a display panel that includes a plurality of pixels and a pixel grid disposed between the plurality of pixels adjacent to each other;
an eyepiece for collecting light emitted from the display panel through the plurality of pixels; and
the optical element according to claim 1 that is disposed on an optical path of the display panel and the eyepiece.

7. The optical element according to claim 2, further comprising:
an overcoat layer that is disposed on the support to cover the dots.

8. The optical element according to claim 2,
wherein the liquid crystal compound is a rod-shaped liquid crystal compound or a disk-shaped liquid crystal compound.

9. The optical element according to claim 3,
wherein the liquid crystal compound is a rod-shaped liquid crystal compound or a disk-shaped liquid crystal compound.

10. The optical element according to claim 4,
wherein the liquid crystal compound is a rod-shaped liquid crystal compound or a disk-shaped liquid crystal compound.

11. A wearable display device comprising:
a display panel that includes a plurality of pixels and a pixel grid disposed between the plurality of pixels adjacent to each other;
an eyepiece for collecting light emitted from the display panel through the plurality of pixels; and
the optical element according to claim 2 that is disposed on an optical path of the display panel and the eyepiece.

12. A wearable display device comprising:
a display panel that includes a plurality of pixels and a pixel grid disposed between the plurality of pixels adjacent to each other;
an eyepiece for collecting light emitted from the display panel through the plurality of pixels; and
the optical element according to claim 3 that is disposed on an optical path of the display panel and the eyepiece.

13. A wearable display device comprising:
a display panel that includes a plurality of pixels and a pixel grid disposed between the plurality of pixels adjacent to each other;
an eyepiece for collecting light emitted from the display panel through the plurality of pixels; and
the optical element according to claim 4 that is disposed on an optical path of the display panel and the eyepiece.

14. A wearable display device comprising:
a display panel that includes a plurality of pixels and a pixel grid disposed between the plurality of pixels adjacent to each other;
an eyepiece for collecting light emitted from the display panel through the plurality of pixels; and
the optical element according to claim 5 that is disposed on an optical path of the display panel and the eyepiece.
